(19) United States
(12) Patent Application Publication
(10) Pub. No.: US 2012/0068027 A1
(43) Pub. Date: Mar. 22, 2012

(54) DEVICE FOR HOLDING PACKAGES

(75) Inventor: Jeffrey D. Tyner, Grand Rapids, MI (US)

(73) Assignee: CND PRODUCTS LLC, Grand Rapids, MI (US)

(21) Appl. No.: 13/305,160

(22) Filed: Nov. 28, 2011

Related U.S. Application Data
(63) Continuation-in-part of application No. 12/649,676, filed on Dec. 30, 2009, now Pat. No. 8,066,237.

(51) Int. Cl. F16M 13/00

(52) U.S. Cl. 248/201; 248/298.1

(57) ABSTRACT

A device for holding one or more dispensing packages includes a rear wall and a pair of retaining elements. The rear wall of the holder may be selectively adjusted to vary the distance between opposing retaining elements. In one embodiment, each retaining element may include a curved portion corresponding to a curved shape of a canister style dispensing container for engaging the sidewalls of the container to support the container between the retaining elements. In another embodiment, the retaining elements may be movable in two dimensions to accommodate containers having different sizes. The retaining elements may additionally include a ramped surface that facilitates flexing of the retaining elements as a container is inserted into the holder.

### BACKGROUND OF THE INVENTION

The present invention relates to dispensing package holders, and, more particularly to a device for holding one or more boxes or packages that are designed for dispensing articles.

Devices for holding packages are particularly common in the medical services industry, for instance, for holding one or more boxes or containers containing medical accessories. One specific example found in many hospital rooms is a device for holding multiple boxes of latex examination gloves, such as a box of small size gloves, a box of medium size gloves and a box of large size gloves. A common configuration of such a glove box holder includes a C-shaped receptacle with an opening at the upper end. Multiple boxes can be inserted through the opening so they are stacked on top of each other within the receptacle. The boxes are oriented within the receptacle such that the openings in the boxes face the gap in the C-shaped receptacle to allow users to remove gloves from the boxes through the gap.

Difficulties arise in the common glove box configuration when attempting to replace an empty glove box. All of the boxes in the receptacle above the empty box must be removed in order to access and remove the empty box. If the bottom box is empty, the top two boxes must therefore unnecessarily be removed in order to remove and replace the empty box. This often creates extra work for already overworked hospital staff members. Difficulties may also arise when limited space is available for the glove boxes.

Further difficulties arise when the holder extends significantly beyond the container it is supporting. For example, a holder that extends beyond the container it is supporting creates an undesirable appearance, could trap dirt and debris in the unoccupied portion of the holder and may be more at risk for contacting hospital personnel or other objects moving close to the holder. Further, a holder that extends beyond the container it is supporting may place undesirable stress on the mounting surface for the holder or on the structure supporting the mounting surface. For example, if a holder is mounted to a relatively small pole for holding intravenous fluids or another mobile device, using a holder that extends farther outward from the pole than the size of the container moves the holder farther away from the center of gravity of the pole than is desired. This could place undesirable stress on the pole itself, or on a base supporting the pole.

Even further difficulties arise in designing holders for dispensing packages having shapes other than the common glove box. For example, it can be difficult to create holders for canister-style dispensers, such as cloth wipe dispensers that dispense wipes from the top or bottom surfaces of the container. These canisters are typically rigid near the top and bottom edges making it difficult to hold the container in such a manner that the wipes are accessible and can be removed with one hand without causing the container to slide with respect to the holder.

### SUMMARY OF THE INVENTION

The present invention provides a front loading device for holding one or more dispensing packages, such that the packages may be independently removed and replaced, and the contents of the packages may be removed from the package without undue movement of the package with respect to the device.

In one embodiment, the holding device includes a rear wall and a pair of sidewalls extending at an angle from said rear wall. The sidewalls each include a one or more of retaining elements, with each retaining element on one of said sidewalls being uniquely associated with a retaining element on the other sidewall. The rear wall may be selectively adjusted to vary the distance between the retaining elements on opposing sides of the sidewall. Various sizes of dispensing packages can be front loaded into the holder between the retaining elements and held in place by the retaining elements. The dispensing packages can also be independently removed from the holder by pulling the packages from between the retaining elements.

In one embodiment wherein the sidewalls include multiple retaining elements, each retaining element is separated from adjacent retaining elements so that each retaining element is independently flexible. For example, the sidewalls may include notches that separate the retaining elements from one another. Each retaining element may include a retention hook that angles from the retaining element to form a surface that can hold a box behind the hook. The hook may additionally include a ramped surface extending from the hook that facilitates flexing of the retaining elements as the boxes are inserted into the holder.

The holder may include a pair of bracket members that connect in a way that provides selective adjustability between the retaining elements. In one embodiment, both bracket members include a rear wall and a plurality of the retaining elements extending from the rear wall. The rear walls of the respective bracket members connect together to form the rear wall of the holder. The rear wall of one of the bracket members may include a slot, and the rear wall of the other bracket member may include a fastener hole that aligns with the slot so that a fastener can be inserted through the hole and tightened at various positions along the slot.

In one aspect of the invention, the holding device includes sidewalls that are configured to retain a canister-style container. For example, the sidewalls may each include a curved section that corresponds to a curved outer wall shape of the canister dispenser. The sidewalls may have a height that is less than the overall height of the canister, such that the sidewalls contact the canister in the central, more flexible portions of the sidewalls for increased retention and compression of the canister. The curved section of the sidewalls may be spaced from the rear wall to provide clearance for one or more fasteners formed integrally with the rear wall. In addition, the upper edge of at least one of the sidewalls may include a support ledge that aids in restricting movement of the canister with respect to the holding device.

In one embodiment, the retaining elements may be moved in two dimensions to accommodate different sized containers. The movement of the two retaining elements may be coordinated, such that they maintain a consistent orientation with regard to one another. The movement of the two retaining elements may tightly hold containers having different dimensions. This may allow the retaining elements to be placed close to a mounting surface of the holding device, which may reduce the stress on the mounting surface.

The present invention enables easy insertion and removal of individual dispensing packages from a single holder, without the need to remove or adjust any other packages in the holder. The invention may further enable retention of various sizes and shapes of containers, while preventing unwanted movement of the container as products are dispensed from the container.

### BRIEF DESCRIPTION OF THE DRAWINGS

FIG. 1 is a front perspective view of a dispensing package holder according to one embodiment of the present invention, wherein a package is positioned in the holder.

FIG. 2 is a front perspective view thereof with no packages in the holder.

FIG. 3 is an exploded view thereof.

FIG. 4 is a rear view thereof.

FIG. 5 is a front perspective view thereof with two packages positioned in the holder.

FIG. 5A is a close up view of the portion of the dispensing package holder in circle A in FIG. 5.

FIG. 6 is a front perspective view of a dispensing package holder according to a second embodiment of the present invention.

FIG. 7 is a front perspective view thereof with the dispensing package holder in a second position.

FIG. 8 is a perspective view of one bracket element according to the second embodiment.

FIG. 9 is a side view thereof.

FIG. 10 is a top view thereof.

FIG. 11 is a perspective view of a second bracket element according to the second embodiment.

FIG. 12 is a side view thereof.

FIG. 13 is a top view thereof.

FIG. 14 is a top view of a dispensing package holder according to the second embodiment with the brackets in a closed position.

FIG. 15 is a top view of a dispensing package holder according to the second embodiment with the brackets in an open position.

FIG. 16 is a perspective view of a dispensing package holder according to the second embodiment with a canister style container in the holder.

FIG. 17 is a side view thereof.

FIG. 18 is a cross sectional view along line A-A in FIG. 17.

FIG. 19 is a cross sectional view of section “B” in FIG. 18.

FIG. 20 is a top view of a dispensing package holder according to the second embodiment with a canister style container in the holder.

FIG. 21 is a top perspective view of a dispensing package holder according to a third embodiment of the present invention.

FIG. 22 is an exploded view thereof.

FIG. 23 is a bottom perspective view thereof with the brackets in a closed position.

FIG. 24 is a bottom perspective view thereof with the brackets in an open position.

FIG. 25 is a top view thereof.

FIG. 26 is a front view thereof.

FIG. 27 is a side view thereof.

FIG. 28 is a top perspective view thereof with the brackets in a closed position.

FIG. 29 is a top view thereof.

FIG. 30 is a rear view thereof.

FIG. 31 is a side view thereof.

### DETAILED DESCRIPTION OF THE CURRENT EMBODIMENTS

I. Overview

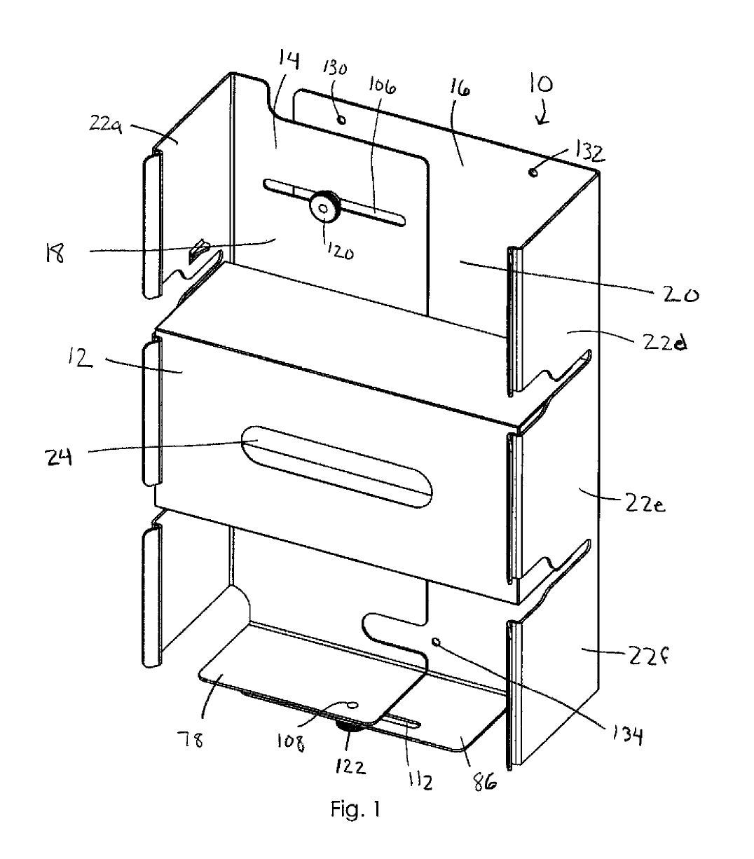

A dispensing package holder according to one embodiment of the present invention is disclosed in FIG. 1 and generally designated 10. In the illustrated embodiment, the dispensing package holder is an apparatus designed to hold boxes 12, which may contain latex examination gloves. The present invention is not, however, limited to boxes or this particular type of box, and may otherwise be used or adapted for use with a wide variety of other types of dispensing packages, such as hair bonnet containers, shoe cover containers, and many others.

As shown, the holder 10 generally includes two bracket elements 14, 16 that each include a base portion 18, 20 and a plurality of retaining elements 22a-f extending outwardly from the base portions 18, 20 for retaining the boxes 12 within the holder. The holder 10 is designed such that each of the retaining elements 22 are independently flexible to enable a user to insert and remove one of the boxes 12 through the front of the holder 10 without interference from the other boxes 12. The bracket elements 14, 16 are connected in a way that enables the distance between the retaining elements 22 on one bracket 14 to be selectively adjusted with respect to the retaining elements 22 on the other bracket 16. This adjustability enables the holder 10 to be adjusted to accommodate boxes 12 and other packages of various widths.

II. Structure

As noted above, the glove boxes 12 are one of many different types of packages that may be held in the holder of the present invention. For purposes of illustration, the present invention will be shown and described in connection with the glove boxes 12. As shown, the glove boxes 12 are generally rectangular, with an oval shaped opening 24 on one side. The opening 24 may be initially covered, for instance, by a perforated cover, and removed when the contents of the box 12 need to be accessed. The contents, such as latex examination gloves, may be removed from the box 12 by pulling them through the opening 24.

The package holder 10 includes two bracket elements 14, 16. In one embodiment, the front bracket element 14 includes a base portion 18 having an upper edge 30, a lower edge 32, first and second side edges 34, 36, a front surface 38 and a rear surface 40. As shown, a sidewall 42 extends outwardly from the front surface 38 at the first side edge 34. In the illustrated embodiment, the sidewall 42 extends generally perpendicular to the base portion 18. The angle, as well as the position of the sidewall 42 on the base portion 18, could be varied from application to application. The sidewall 42 includes a base 44 adjacent the base portion 18 and a distal end 46 opposite the base 44. As shown, the sidewall 42 includes two notches 48, 50 extending into the sidewall 42 from the distal end 46, forming three separate retaining elements 22a, 22b and 22c. The notches 48, 50 enable each of the retaining elements 22a-c to flex independently of the other retaining elements. The degree of flexibility can be controlled by changing the depth and width of the notches. In the illustrated embodiment, the notches 48, 50 extend from the distal end 46 thorough substantially all of the sidewall 42, and they taper from an initial width near the distal end 46 of the sidewall 18 to a narrower width approaching the base 44. Although the illustrated embodiment includes two notches and three retaining elements 22, other embodiments may have only two retaining elements or more than three retaining elements.

In one embodiment, the rear bracket element 16 includes a base portion 20 having an upper edge 60, a lower edge 62, first and second side edges 64, 66, a front surface 68 and a rear surface 70. A sidewall 72 extends outwardly from the front surface 68. The retaining elements 22d-f extending from the rear bracket element 16 are essentially a mirror image of the retaining elements 22a-c extending from the front bracket element 14, and therefore will not be described again in detail. When the front 14 and rear 16 bracket elements are connected, each retaining element 22a-c on the front bracket element 14 is uniquely associated with one of the retaining elements 22d-f on the rear bracket element 16, such that they form coupled pairs of retaining elements 22. For example, retaining elements 22a and 22d form a first coupled pair of retaining elements, retaining elements 22b and 22e form a second coupled pair and retaining elements 22c and 22f form a third coupled pair. In the illustrated embodiment, the retaining elements of each coupled pair are generally aligned with each other when the front 14 and rear 16 bracket elements are connected. In another embodiment, the retaining elements may be offset from each other, or of different sizes such that a retaining element on one bracket element may have a different size or shape as its coupled pair. In yet another embodiment, only one of the two retaining elements in a coupled may be flexible. For instance, in one embodiment, only one of the two sidewalls 42, 72 may include notches 48, 50.

The package holder 10 may include ledges for supporting the boxes 12 at different heights and preventing the boxes 12 from interfering with each other as they are inserted or removed from the holder 10. In the illustrated embodiment, the front bracket element 14 includes three ledges 74, 76 and 78 for supporting boxes 12 at three different heights, with each height corresponding to the location of one of the coupled pairs of retaining elements 22. The upper ledge 74 is punched from the center of one of the retaining elements 22a, and bent inwardly from the retaining element 22a approximately perpendicular to the retaining element 22a. The ledge 74 is triangular in shape, having a width that increases towards the base 44 of the sidewall 42. The center ledge 76 is formed from a piece of material that extends from the lower edge 80 of the retaining element 22b. Like the ledge 74, the ledge 76 extends approximately perpendicular to the sidewall 42 and is triangular in shape. The bottom ledge 78 is a flange that extends outwardly from the lower edge 32 of the base portion 18 of the front bracket element 14. The ledge 78 is generally rectangular, and it extends from the base portion 18 approximately perpendicular to the base portion 18. In the illustrated embodiment, the ledge 78 extends the entire width of the base portion 18. In an alternative embodiment, any of the ledges 74, 76, and 78 may extend from either the sidewall 42 or from the base portion 18, and the size and shape of the ledges may vary from application to application. The ledges 74, 76 may also act as a barb contacting the container side, which may increase the friction to keep the container from sliding vertically. The rear bracket element 16 may also include three ledges 82, 84, and 86. In the illustrated embodiment, the upper ledge 82 and center ledge 84 on the rear bracket 16 extend outwardly from the lower edges 88, 90 of the retaining elements 22d and 22e respectively. As shown, the heights of the ledges 82 and 84 are offset from the corresponding ledges 74 and 76 on the front bracket element 14 to enable an upper box 12 to be seated on either ledge 74 or 82 and a central box 12 to be seated on ledge 76 or 84. This allows the holder 10 to accommodate boxes of varying heights. The lower ledge 86 on the rear bracket 16 extends from the lower edge 62 of the base portion 20 in the same manner as the lower ledge 78 on the front bracket 14.

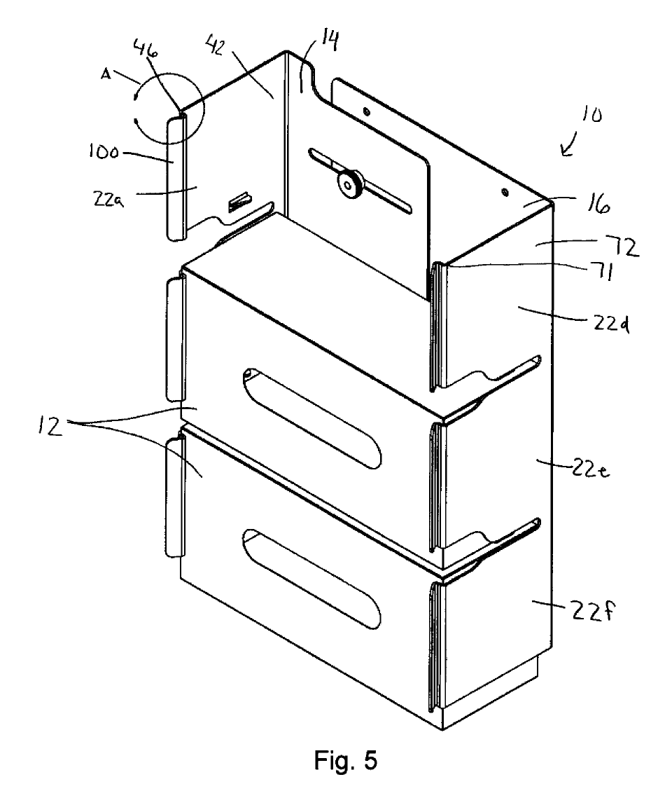

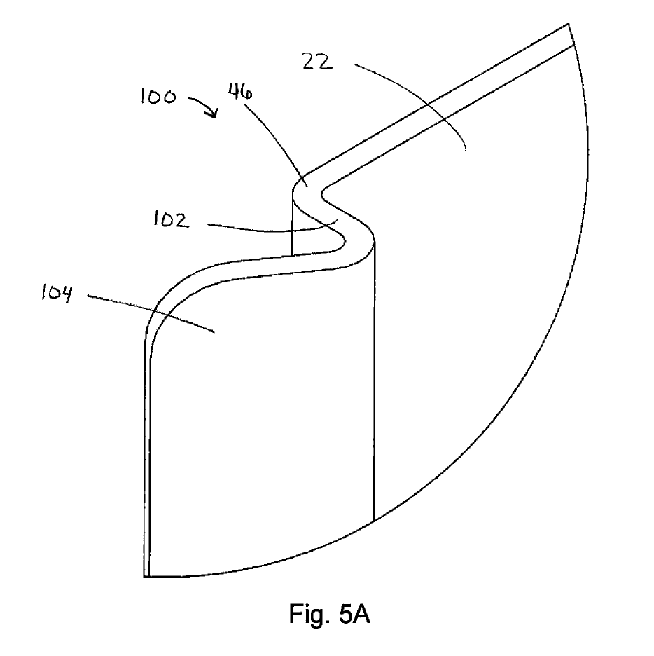

As shown in FIG. 5, and more particularly in FIG. 5A, each retaining element 22a-f may include a retainer hook 100. In one embodiment, the retainer hooks are shaped to facilitate flexing of the retaining members 22a-f when a box 12 is inserted between the retaining members 22a-f and to retain the boxes 12 behind the retainer hook 100 when they are inserted beyond the retainer hooks 100. In the illustrated embodiment, the retainer hooks extend from the distal end 46 of the sidewall 42 and the distal end 71 of the sidewall 72, and each retainer hook 100 includes a retention portion 102 extending inwardly toward the opposing sidewall and a flex portion 104 extending at an angle from the retention portion 102. As shown, the retention portion 102 extends from the retaining element 22a-f at an angle approximately perpendicular to the retaining element 22a-f and the flex portion 104 extends from the retention portion 102 such that it is angled outwardly (i.e. away from the opposing sidewall). In this way, the retention portion 102 forms a ramped surface that, when engaged by a box 12, will flex the retaining element 22a-f outwardly to allow the box 12 to pass beyond the retaining hook 100. In an alternative embodiment, the retaining hooks may have another shape. For instance, the retaining hooks may include only the retention portion 102. Optionally, the holder may not include retaining hooks 100, and may retain the boxes in another manner, such as the frictional resistance of the retaining elements 22a-f on the sides of the boxes 12.

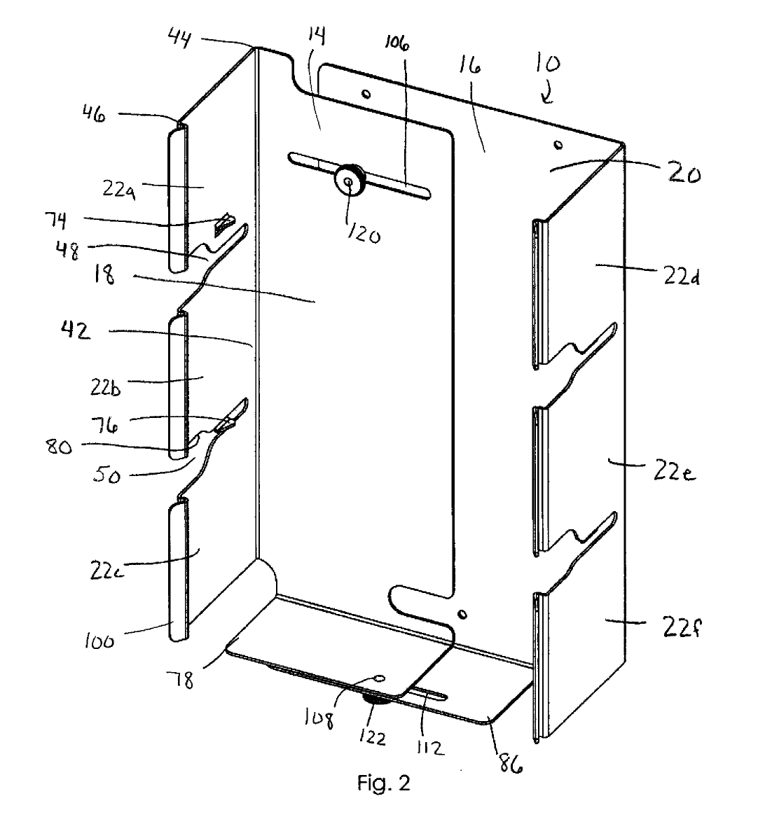

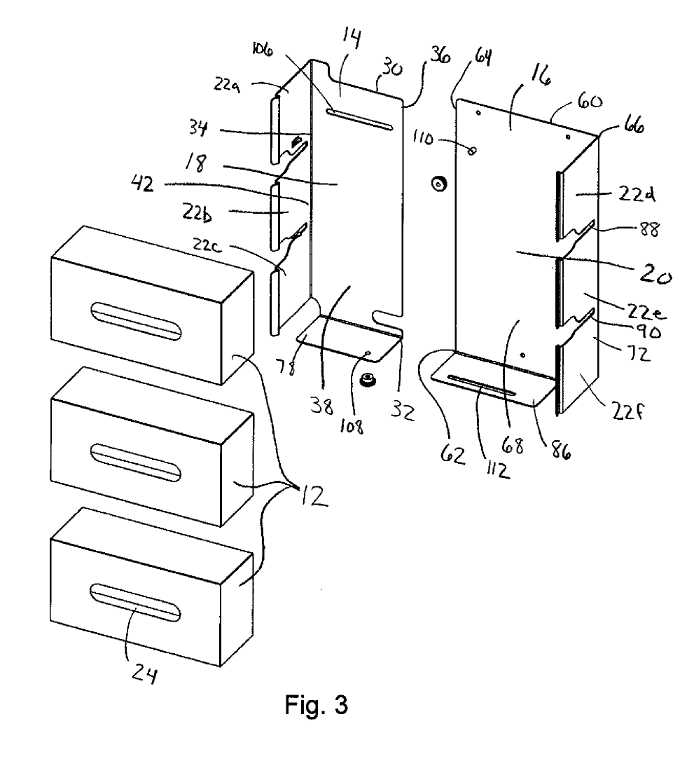

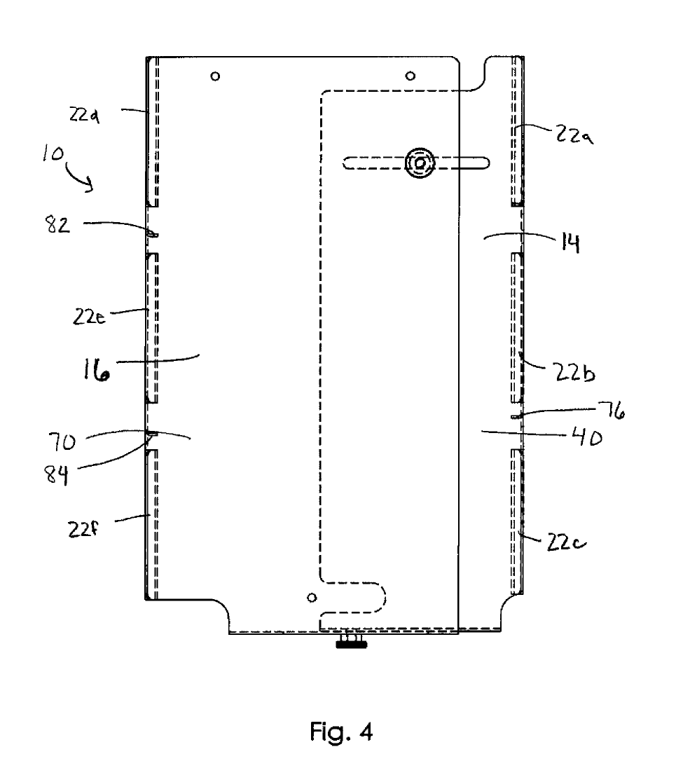

The front 14 and rear 16 bracket elements are connected together in a way that allows the distance between the coupled pairs of retaining elements 22a-f to be selectively adjusted to accommodate for boxes of varying widths. In the illustrated embodiment, the front bracket member 14 includes an elongated slot 106 extending across the base portion 18 and a fastener hole 108 on the lower ledge 78, and the rear bracket member 16 includes a fastener boss 110 extending from the base portion 20 and an elongated slot 112 extending across the lower ledge 86. As shown in FIG. 2, the slot 106 is positioned to align with the fastener boss 110 and the slot 112 is positioned to align with the fastener hole 108 when the front bracket member 14 is positioned in front of the rear bracket member 16 such that fasteners 120, 122 can extend through the aligned slots and holes to secure the front 14 and rear 16 bracket members together. The fasteners 120, 122 may be repositioned within the slots 106, 112 to selectively adjust the position of the front bracket portion 14 with respect to the rear bracket portion 16 and the distance between opposing retaining elements 22a-f. In the illustrated embodiment, the fasteners 120, 122 each include screw portion (not shown) and a knob 124 that enables a user to easily loosen and tighten the screw portion of the fasteners 120, 122 to easily adjust the distance between the retaining elements 22a-f. A variety of alternative embodiments may be used to enable the selective adjustability of the front and rear brackets 14, 16. For example, the slots 106, 112 may be replaced with a series of holes, or the slots may be eliminated and the fasteners may be configured to tighten directly against the front surface 68 of the rear bracket 16.

In addition, the front 14 or rear 16 brackets may include structure for mounting the holder 10 to a support structure, such as a wall or a rail mounting system. As illustrated, the rear bracket portion 16 includes three mounting holes 130, 132, 134 that receive fasteners for mounting the rear bracket portion 16, and thus the holder 10, to a wall. In another embodiment, the holes may be repositioned to attach to a particular rail structure. Other methods for mounting the holder 10 to a support structure, such as hooks on the rear surface 70 of the rear bracket 16.

III. Operation

Operation of the illustrated embodiment generally includes mounting the rear bracket member 16 to a support structure using the fastener holes 130, 132, 134 by extending conventional fasteners (not shown) through the holes and into the support structure, or into a clip that attaches to the support structure. Of course, in an embodiment with mounting structure on the front bracket 14, the front bracket may be mounted to the support structure in addition to or instead of the rear bracket. The front bracket member 14 is attached to the rear bracket member 16 by extending the fastener 120 through the slot 106 and the fastener boss 110 and the fastener 122 through the slot 112 and the fastener hole 108. At that point, a box 12 that is intended to be held in the holder 10 is positioned between one of the coupled pairs of retaining members 22a-f and the distance between the retaining members 22 in the coupled pair is adjusted by sliding the front 14 and rear 16 brackets with respect to each other via the slots 106 and 112 until the retaining members of the coupled pair contact, or nearly contact, the box 12 and the retainer hooks 100 are positioned in front of a portion of the box 12 to retain the box 12 behind the hooks 100. The fasteners 120, 122 are then secured by tightening the screws 120, 122 to keep the brackets 14, 16 in the desired position.

When the brackets 14, 16 are in the desired position, the holder 10 is ready for use. Boxes 12 may be inserted between coupled pairs of the retaining elements 22a-f until they are retained behind the retainer hooks 100 and supported by one or more ledges 74, 76, 78 or 82, 84, or 86. In the illustrated embodiment, as a box 12 is brought into contact with the flex portion 104 of a retainer hook 100, the ramped surface of the flex portion 104 is forced outwardly, causing the retaining element 22a-f corresponding to that retainer hook 100 to flex outwardly, independent from the other retaining elements 22a-f, until the box 12 has been inserted past the retention portion 102 of the retainer hook 100. Also in the illustrated embodiment, with ledges on opposing sidewalls 42, 72 that are offset in height from each other, each box 12 may be vertically supported by only one ledge. The particular ledge is selected by the user based on the height of the box 12. If a ledge on the opposing side of the holder 10 interferes with the box 12, the triangle shape of the ledge may help to deform the box 12 or even puncture the box 12 to allow the box 12 to fit in the selected position. Boxes 12 can be individually removed from the holder 10 by flexing one or both of the retaining elements in a corresponding pair outwardly to enable the box 12 to be pulled from behind the retention hook 100.

IV. Second Embodiment

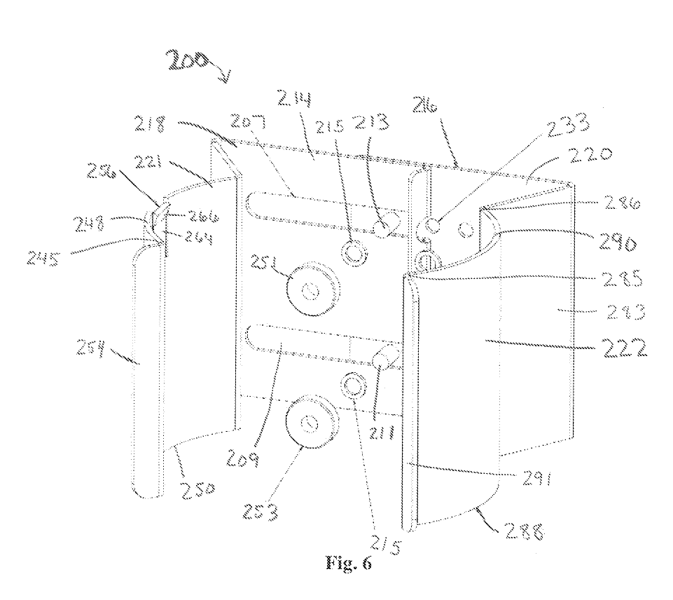

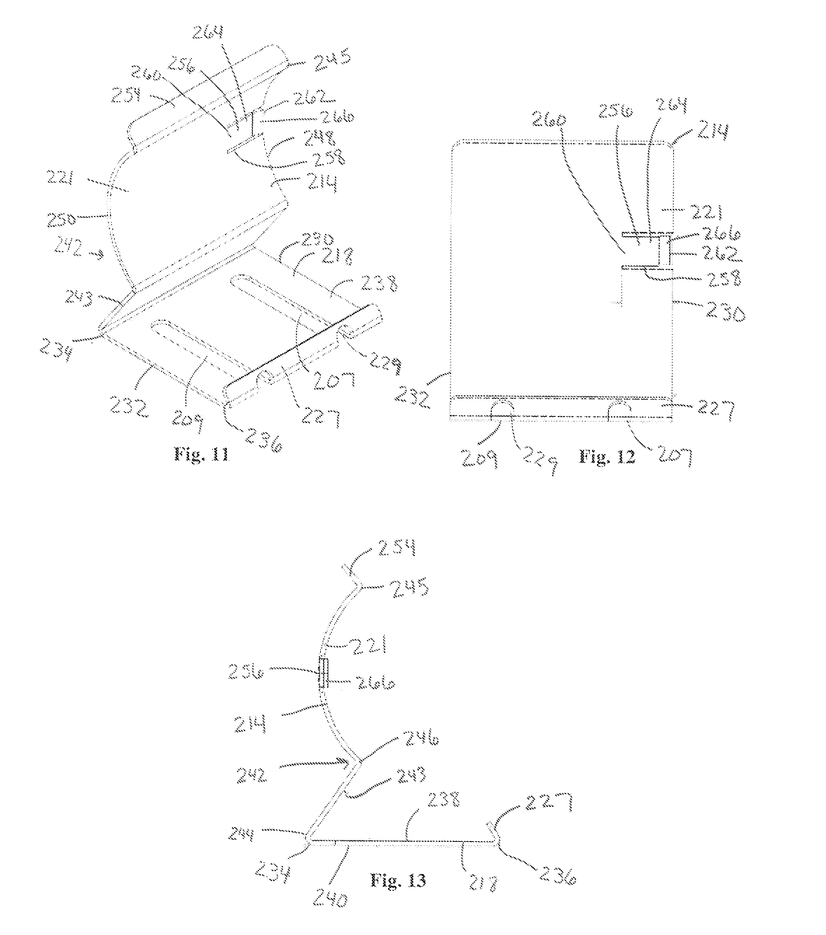

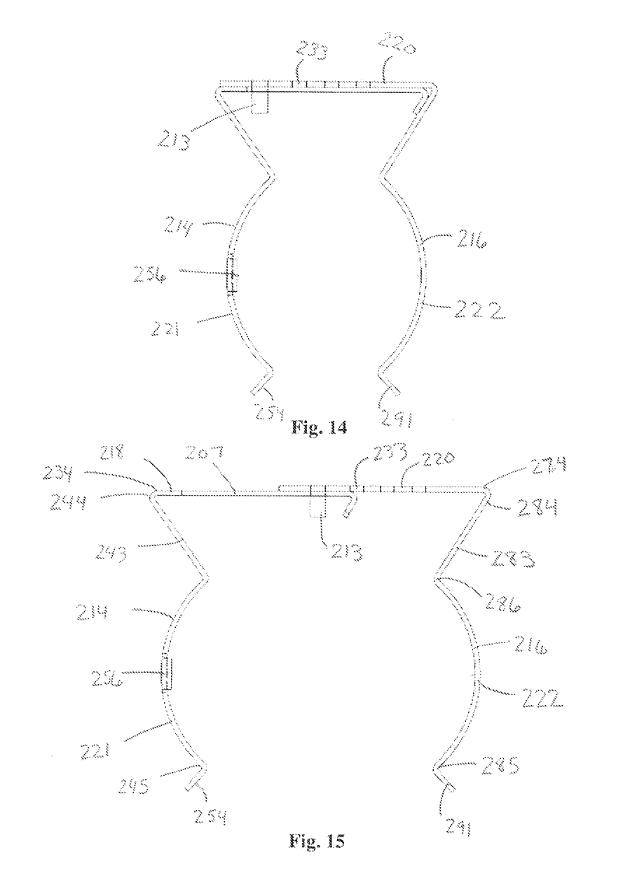

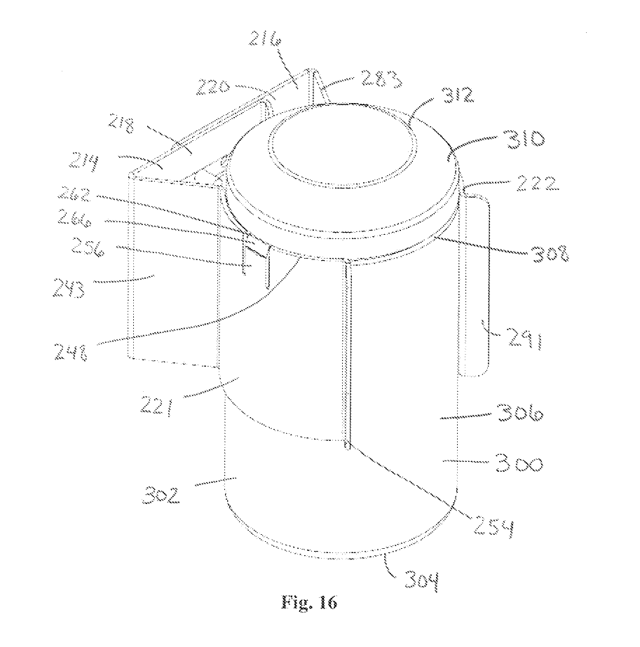

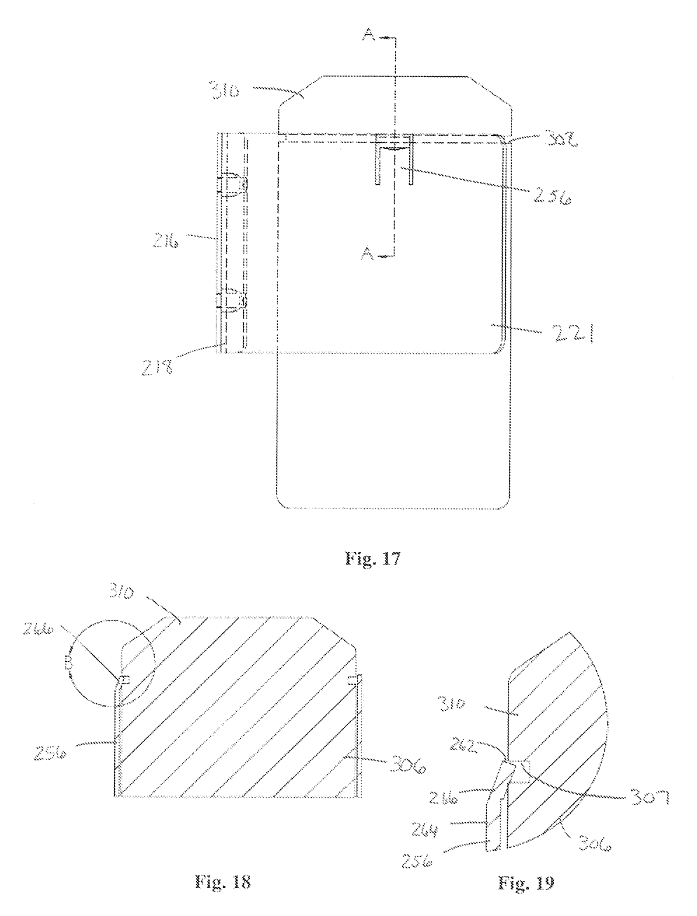

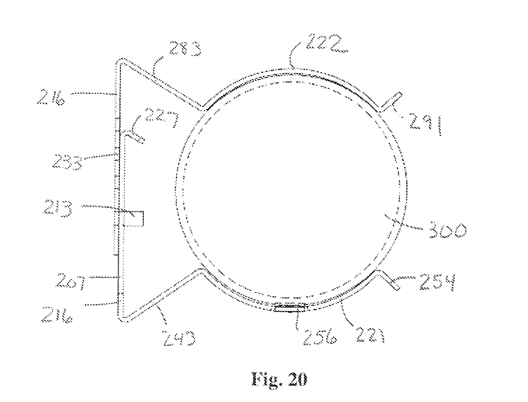

A second embodiment of the invention is shown in FIGS. 6-20. In this embodiment, the package holder 200 is configured to receive and retain a canister style package 300, such as a cylindrical container for holding and dispensing products such as “wet wipes.” In one embodiment (shown in FIGS. 16-20), these canister style packages 300 include a cylindrical container 302 that is generally formed from molded plastic and includes a bottom 304, a sidewall 306, and an open top 308. The open top 308 may include external threads or another attachment structure for securing a cap 310 over the open top to close the opening. The cap 310 generally includes a secondary opening 312 through which the individual wet wipes may be dispensed. For example, the wet wipes may be dispensed by a user by pulling individual wet wipes through the secondary opening 312 in the cap 310. The typical canister style package may be relatively rigid near the bottom of the container and near the top cap due to the increased amount of material in those locations, whereas the container may be relatively flexible in the locations near the midpoint between the bottom of the container and the top cap 310 due to the reduced amount of material.

As shown in FIGS. 6-15, the package holder 200 generally includes two bracket elements 214, 216 that, similar to the first embodiment, each include a base portion 218, 220 and a retaining portion 221, 222 extending from the base portions 218, 220 respectively for retaining a canister style package between the retaining elements 221, 222. The holder 200 is designed such that the retaining elements 221, 222 are shaped to correspond to the external shape of the package 300. The bracket elements 214, 216 are connected in a way that enables the distance between the retaining elements 221, 222 to be selectively adjusted with respect to one another. As in the first embodiment, this adjustability enables to holder 200 to be adjusted to accommodate canister style packages and other packages of various widths and diameters.

Referring to FIGS. 11-13, in one embodiment, the front bracket element 214 includes a base portion 218 having an upper edge 230, a lower edge 232, first and second side edges 234, 236, a front surface 238 and a rear surface 240. As shown, a sidewall 242 extends outwardly from the front surface 238 at the first side edge 234. In one embodiment, the sidewall 242 includes an extension section 243 extending from the base portion 218 at an angle from the base portion 218. As shown, the extension section 243 extends from the base portion 218 at about a 60 degree angle. The angle, as well as the position of the sidewall 242 on the base portion 218, could be varied from application to application. In the illustrated embodiment, the extension section 243 is generally straight, and includes a base 244 adjacent the base portion 218, and an outer edge 246 opposite the base 244.

The sidewall 242 may further include a retaining element, or retainer, 221 extending outwardly from the extension section 243. As shown, the retaining element 221 extends from the outer edge 246 of the extension section 243 to a distal edge 245, and may include an upper edge 248 and a lower edge 250. The retaining element 221 may be shaped to correspond to the shape of the external surface of a package to be inserted into the holder 200. For example, as shown in FIGS. 16-20, the retaining element 221 has a curved shape that generally matches the external shape of the cylindrical, canister-style product dispenser 300. The retaining element 221 illustrated in the Figs. has a continuously curved arc shape, however, in an alternative embodiment, only portions of the retaining element may be curved. In another embodiment, the retaining element may be configured with a different shape altogether, in order to closely match the shape of another style of container. Matching the shape of the container may increase friction forces to retain the container.

The retaining element 221 may include a ramp portion 254 extending outwardly from the distal edge 245 and extending at an angle from the retaining element 221. As shown, the ramp portion 254 extends from the element 221 such that it is angled outwardly (i.e. away from the opposing sidewall). In this way, the ramp portion 254 forms a ramped surface that, when engaged by a container, will flex the retaining element 221 outwardly to allow the container to pass beyond the ramp portion 254 and into contact with the curved retaining element 221.

In one embodiment, the retaining element 221 may also include a support ledge 256. As shown in FIGS. 6, 7 and 11-13, the retaining element 221 may include a cutout 258 in the upper edge 248, and the support ledge 256 may be a tab that extends upwardly within the cutout from a base 260 to a distal end 262 that is generally flush with the upper edge 248 of the retaining element 221. As a result of the support ledge 256 being connected to the retaining element 221 only at the base 260, the support ledge 256 is capable of flexing with respect to the retaining element 221. In the illustrated embodiment, the support ledge 256 includes an upright portion 264 adjacent the base 260, and an angled portion 266 extending from the upright portion 264. As shown, the angled portion 266 angles inwardly toward the opposing retaining portion 222. Referring to FIGS. 18-19, the angled portion 266 is capable of extending between the container portion 302 and a lid portion 310 of the canister style container 300 to support the lower edge 307 of the lid 302 and prevent the canister style container 300 from slipping downwardly when it is retained in the holder 200. In an alternative embodiment, the holder 200 may not include the cutout 258 and support ledge 256, and instead rely solely on the inward force of the retaining elements 221, 222 on the outer wall of the container 300 to retain the container between the retaining elements 221, 222 and prevent movement of the container 300. In yet another alternative embodiment, the retaining element 221 may include multiple cutouts 258 and support ledges 256. The opposing retaining element 222 may otherwise include one or more support ledges 256.

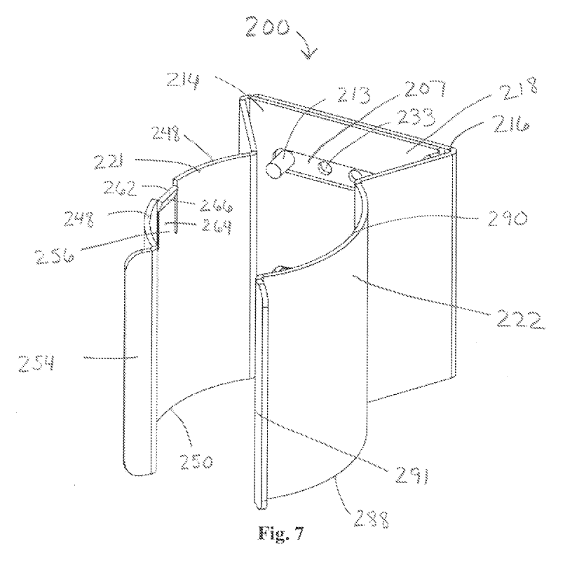

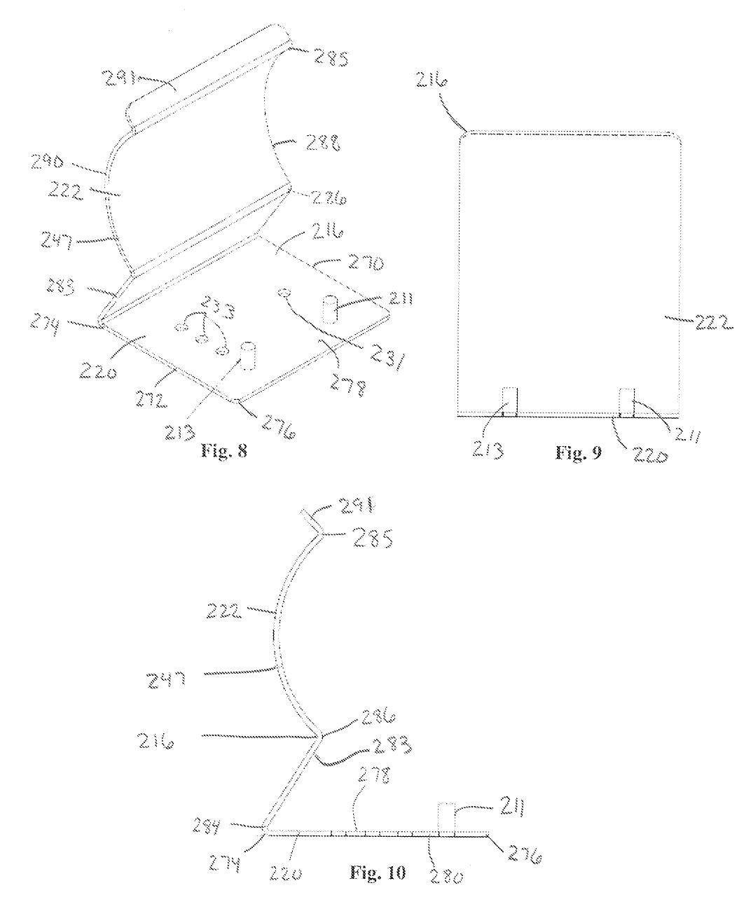

Referring to FIGS. 8-10, in one embodiment, the rear bracket element 216 includes a base portion 220 having an upper edge 272, a lower edge 270, first and second side edges 274, 276, a front surface 278 and a rear surface 280. A sidewall 247 extends outwardly from the front surface 278 at the first side edge 274. In one embodiment, the sidewall 247 includes an extension section 283 extending from the base portion 220 at an angle from the base portion 220. The extension section 283 may extend from the base portion 220 at about a 60 degree angle toward the opposing sidewall 242. As noted above, the angle of the extension section 283, as well as the position of the sidewall 247 on the base portion 220, could be varied from application to application. In the illustrated embodiment, the extension section 283 is generally straight, and includes a base 284 adjacent the base portion 220, and an outer edge 286 opposite the base 284.

The sidewall 247 may further include a retaining element 222 extending outwardly from the extension section 283. As shown, the retaining element 222 extends from the outer edge 286 of the extension section 283 to a distal edge 285, and may include an upper edge 290 and a lower edge 288. The retaining element 222 may be shaped to mirror the shape of the opposing retaining element 221, such that its shape corresponds to the shape of the external surface of a package 300 to be inserted into the holder 200. For example, as shown in FIGS. 16-20 the convex curved shapes of the retaining elements 221, 222 generally match the external shape of the cylindrical, canister-style product dispenser 300 to contact the sidewall 306 of the container portion 302. Alternatively, the retaining element 222 may be configured with a different shape altogether, in order to closely match the shape of another style of container.

Like the retaining element 221, the retaining element 222 may include a ramp portion 291 extending outwardly from the distal edge 285 and extending at an angle from the retaining element 222. As shown, the ramp portion 291 is essentially a mirror-image of the ramp portion 254. The ramp portions 291 and 254 combine to form ramped surfaces that, when engaged by a container, will flex the retaining elements 221, 222 apart from each other to allow the container to pass beyond the ramp portions 254, 291 and into contact with the retaining elements 221, 222.

In a manner similar to the first embodiment, the front 214 and rear 216 bracket elements may be connected together in a way that allows the distance between the retaining elements 221, 222 to be selectively adjusted to accommodate for containers of varying diameters. As shown in the figures, the base portion 218 of the front bracket member 214 may at least partially overlap the base portion 220 of the rear bracket member 216. In the illustrated embodiment, the front bracket member 214 includes a pair of elongated slots 207, 209 extending across the base portion 218, and the rear bracket member 216 includes fastener bosses 211, 213 extending from the base portion 220. As shown in FIG. 6, the slot 207 is positioned to align with the fastener boss 213 and the slot 209 is positioned to align with the fastener boss 211 when the front bracket member 214 is positioned in front of the rear bracket member 216 such that fasteners 251, 253 can attach to the bosses 211, 213 extending through the slots 207, 209 to secure the front 214 and rear 216 bracket members together. The fasteners 251, 253 may be repositioned within the slots 207, 209 to selectively adjust the position of the front bracket portion 214 with respect to the rear bracket portion 216 and the distance between opposing retaining elements 221, 222. Similar to the first embodiment, the fasteners 251, 253 may each tighten onto the bosses 213, 211 respectively to easily adjust the distance between the retaining elements 221, 222. Washers 215 may be positioned between the fasteners 251, 253 and the base 218. A variety of alternative embodiments may be used to enable the selective adjustability of the front and rear brackets 214, 216. For example, the slots 207, 209 may be replaced with a series of holes, or the slots may be eliminated and the fasteners may be configured to tighten directly against the front surface of the rear bracket 216.

In one embodiment, the canister holder 200 includes integral structure for attaching the holder 200 to a support structure, such as a wall or upright support. Referring to FIG. 6, the base 220 of the rear bracket 216 may include one or more holes 231 aligned with the first boss 211 and one or more holes 233 aligned with the second boss 213. In this way, the holes 233, 231 align with the slots 207, 209 in the front bracket 214 when the front and rear brackets are attached to one another to accommodate for a fastener (not shown) extending through a desired one of the holes 233 and the hole 231 to attach the holder 200 to the support structure. The slots 207, 209 are thus utilized to receive both: (1) the fasteners 251, 253 for securing the first 214 and second 216 brackets together and (2) the fasteners (not shown) that attach the holder 200 to a support structure. The front bracket 214 may be constructed to accommodate for the fasteners that attach the holder 200 to a support structure and provide structure to enable adjustment of the front bracket 214 with respect to the rear bracket 216. As shown, the base 218 of the front bracket includes an outwardly extending flange 227. In the illustrated embodiment, the flange 227 extends at about a sixty degree angle from the second side edge 236 of the base 218. In one embodiment, the flange 227 extends outwardly to a distance that is less than the distance between the base 218 and the outer edges 246, 286 of the extension sections 243, 283 such that the container does not contact the flange 227 when held in the holder 200. The flange 227 may include notches 229 that align with and extend from the slots 207, 209 in the front bracket 214 to provide clearance for any fasteners extending through the slots 207, 209.

V. Third Embodiment

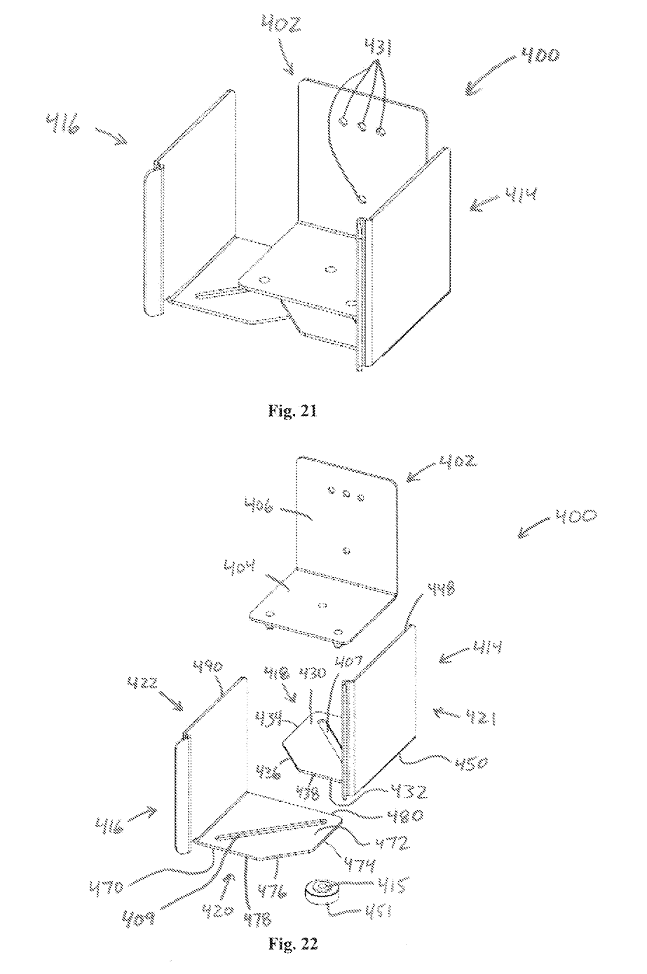

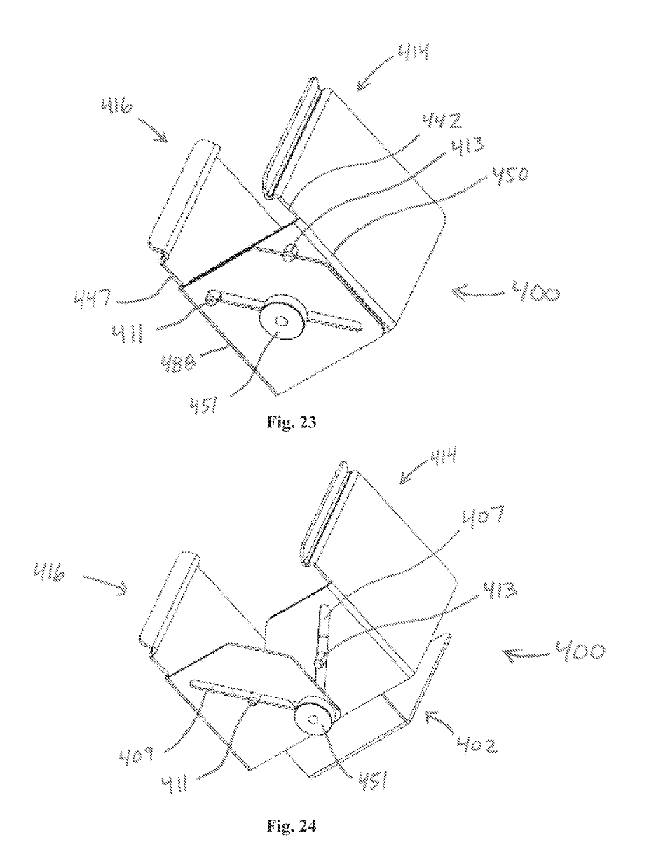

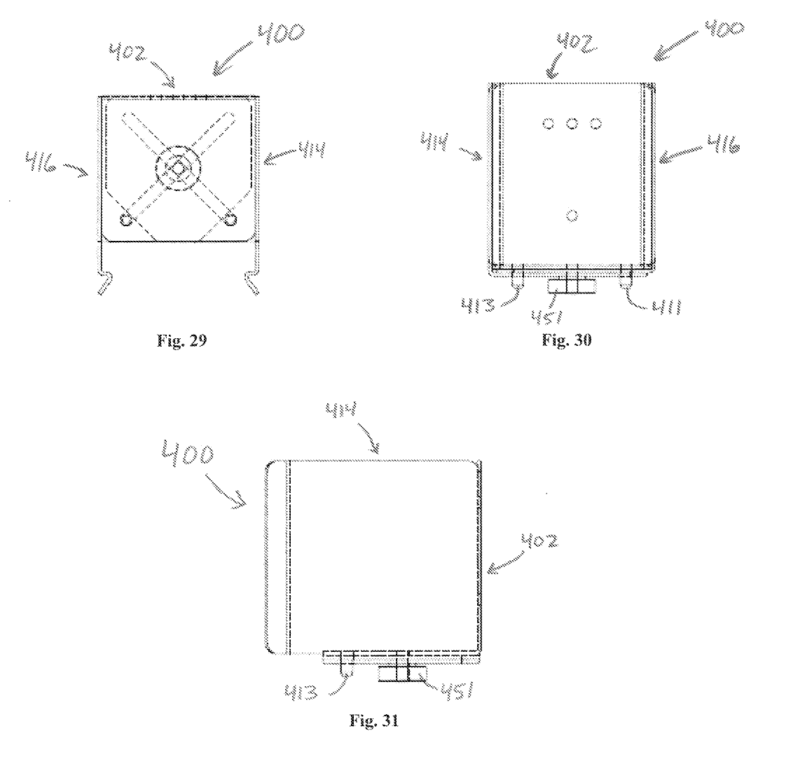

A third embodiment of the invention is shown in FIGS. 21-31. In this embodiment, the package holder 400 is configured to adjust in two dimensions to accommodate containers of varying sizes.

As shown in FIGS. 21-31, the package holder 400 generally includes a base element 402 and two bracket elements 414, 416. The base element 402 includes a base portion 404 and an upright portion 406. Each of the bracket elements 414, 416 include a base portion 418, 420 and a retaining portion 421, 422 extending from the base portions 418, 420 respectively for retaining a package between the retaining elements 421, 422. The bracket elements 414, 416 are connected in a way that enables the distance between the retaining elements 421, 422 to be adjusted. The bracket elements 414, 416 are also connected to the base element 402 in a way that enables the distance between the bracket elements 414, 416 and the upright portion 406 of the base element 402 to be adjusted. In this manner, this embodiment may be adjusted in two dimensions to accommodate different sized containers.

Referring to FIGS. 21-31, in one embodiment, the top bracket element 414 includes a base portion 418 having an upper surface 430, a lower surface 432, first and second side edges 434, 436, a front edge 438 and a rear edge 440. A retaining element, or retainer, 421 may extend upwardly from the upper surface 430. As shown, the retaining element 421 extends outward to a distal edge 445, and may include an upper edge 448 and a lower edge 450. The retaining element 421 may be shaped to correspond to the shape of the external surface of a container to be inserted into the holder 400. For example, as shown in FIGS. 21-31, the retaining element 421 may have a substantially planar shape that generally matches the external shape of a container with a substantially planar sidewall. Although the illustrated embodiment includes a substantially planar retaining element 421, in another embodiment, only portions of the retaining element 421 may be substantially planar. In another embodiment, the retaining element 421 may be configured with a different shape altogether, in order to closely match the shape of another style of container. For example, the retaining element could have a curved shape similar to the second embodiment. Matching the shape of the container may increase friction forces to retain the container.

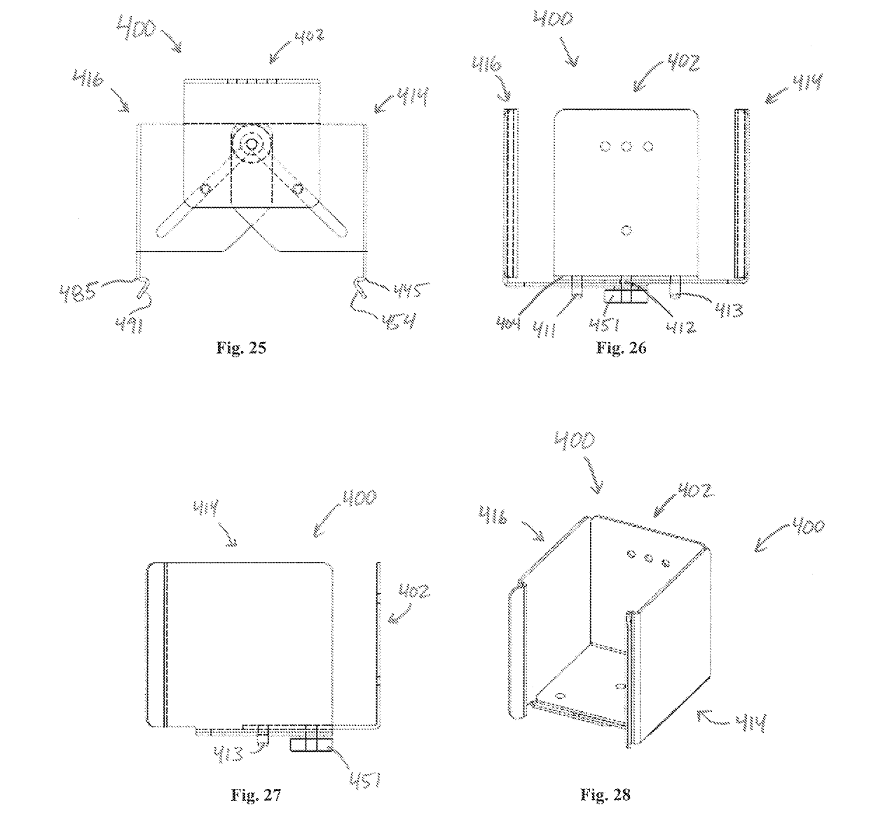

As shown in FIG. 25, the retaining element 421 may include a ramp portion 454 extending outwardly from the distal edge 445 and extending at an angle from the retaining element 221. As shown, the ramp portion 454 extends from the element 421 such that it is angled outwardly (i.e. away from the opposing retaining element 422). In this way, the ramp portion 454 forms a ramped surface that, when engaged by a container, will flex the retaining element 421 outwardly to allow the container to pass beyond the ramp portion 454 and into contact with the retaining element 421. A portion of lower edge 450 may form an open edge 442 in the sense that open edge 442 may not be attached to base portion 418. Open edge 442 allows for additional flexing of ramp portion 454 when a container engages the ramp portion 454.

Referring to FIGS. 21-31, in one embodiment, the bottom bracket element 416 includes a base portion 420 having an upper surface 472, a lower surface 470, first and second side edges 474, 476, a front edge 478 and a rear edge 480. A retaining element, or retainer, 422 may extend upwardly from the upper surface 472. As shown, the retaining element 422 extends outward to a distal edge 485, and may include an upper edge 490 and a lower edge 488. The retaining element 422 may be shaped to mirror the shape of the opposing retaining element 421, such that its shape corresponds to the shape of the external surface of a container to be inserted into the holder 400. For example, as shown in FIGS. 21-31, the substantially planar shapes of the illustrated retaining elements 421, 422 would generally match the external shape of a container with a substantially planar sidewall to contact the substantially planar sidewall of the container. Alternatively, the retaining element 422 may be configured with a different shape altogether, in order to closely match the shape of another style of container.

Like the retaining element 421, the retaining element 422 may include a ramp portion 491 extending outwardly from the distal edge 485 and extending at an angle from the retaining element 422. As shown, the ramp portion 491 is essentially a mirror-image of the ramp portion 454. The ramp portions 491 and 454 combine to form ramped surfaces that, when engaged by a container, will flex the retaining elements 421, 422 apart from each other to allow the container to pass beyond the ramp portions 454, 491 and into contact with the retaining elements 421, 422. Similar to the retaining element 421, the lower edge 488 of retaining element 422 may have a portion that forms an open edge 447 in the sense that open edge 447 may not be attached to base portion 420. Open edge 447 allows for additional flexing of ramp portion 491 when a container engages the ramp portion 491.

The bracket elements 414, 416 may be connected together in a way that allows the distance between each of the retaining elements 421, 422 and the distance between the distal edges 445, 485 and the upright portion 406 of base element 402 to be selectively adjusted to accommodate for containers of varying lengths, widths and sizes. As shown in FIGS. 21-31, the base portion 418 of the top bracket element 414 may at least partially overlap the base portion 420 of the bottom bracket element 416. In the illustrated embodiment, the top bracket element 414 includes an elongated slot 407 extending across the base portion 418, and the bottom bracket element 416 includes an elongated slot 409 extending across the base portion 420. As illustrated, the slots 407, 409 are substantially straight and are oriented at approximately a 45 degree angle with respect to the upright portion 406. In another embodiment, the angle of the slots 407, 409 may be varied to accommodate a desired range of container sizes. In an even further embodiment, the slots may be another shape as may be desired for other applications. For example, the slots 407, 409 may be shaped in an ellipse, radius or other non-linear configuration. Further, the slots 407, 409 may include some type of indexing to correspond to particular shapes and sizes of containers. For example, the slots 407, 409 may each have a zig-zag configuration or include notches so that a user will be able to positively locate the bosses 411, 412, 413 at a desired position to accommodate a container of a particular size.

As shown in FIG. 26, the base element 402 includes fastener bosses 411, 412, 413 extending from the base portion 404. As shown in FIG. 24, the slot 407 is positioned to align with the fastener boss 413, the slot 409 is positioned to align with the fastener boss 411, and the slots 407, 409 are both aligned with fastener boss 412 when the top bracket member 414 and the bottom bracket member 416 are positioned below base element 402. In another embodiment, the bosses 411, 412, 413 may extend from a top surface of the base portion 404 and the top bracket 414 and rear bracket 416 may be positioned above the base portion 404.

As shown in FIG. 26, a fastener 451 can attach to the boss 412 extending through the slots 407, 409 to secure the top bracket element 414, the bottom bracket element 416 and the base element 402 together. Optionally, the fastener 451 can attach to any one of the bosses 411, 412, 413. Further optionally, more than one fastener may be used so that more than one of the bosses 411, 412, 413 have corresponding fasteners. The bosses intended to receive fasteners may be threaded or otherwise configured to receive the fasteners, while the bosses not intended to receive fasteners may be a smooth guide post or other suitable configuration.

The fastener 451 may be repositioned within the slots 407, 409 to selectively adjust the position of the front bracket 414 with respect to the rear bracket 416 and the distance between opposing retaining elements 421, 422. Repositioning the fastener 451 within the slots 407, 409 also selectively adjusts the position of the distal edges 445, 485 with respect to the upright portion 406 of the base element 402. In this manner, the holder 400 is adjustable in two dimensions to receive containers of various sizes. This may provide more adjustability and may assist in positioning the retaining elements 421, 422 closely adjacent the sidewalls of the container. Further, this configuration may allow the distal edges 445, 485 to be positioned closely adjacent the edges of the container.

The fastener 451 may tighten onto the boss 412 to easily adjust the distance between the retaining elements 421, 422 and the distance between the distal edges 445, 485 and the upright portion 406. For example, the fastener 451 may be loosened from the boss 412, the top and bottom brackets 414, 416 may be moved to a desired position, and the fastener 451 may be tightened onto the boss 412 to secure the brackets 414, 416 and the base element 402 relative to one another. In the illustrated embodiment, the bosses 411, 412, 413 maintain the alignment of top bracket 414 and bottom bracket 416 so that each distal edge 445, 485 is positioned at substantially the same distance from the upright portion 406 and so that each retaining element 421, 422 is positioned at substantially the same distance from boss 412. In the illustrated embodiment, the bosses 411, 412, 413 also maintain the retaining elements 421, 422 substantially parallel to one another as the top bracket 414 and bottom bracket 416 are moved. In another embodiment, the bosses may be positioned to maintain another desired configuration for receiving a container having a particular range of sizes and shapes. The respective second edges 436, 476 of each base portion 418, 420 may be shaped to substantially correspond to the shape of the slots 407, 409. For example, the second edges 436, 476 may be shaped to avoid any undesirable contact between the bosses 411, 413 and the second edges 436, 476 during movement of the top bracket 414 and rear bracket 416. As shown in the figures, the second edges 436, 476 of the illustrated embodiment are substantially straight and are oriented substantially at a 45 degree angle to match the configuration of the slots 407, 409.

A washer 415 may be positioned between the fastener 451 and the base 420. A variety of alternative embodiments may be used to enable the selective adjustability of the front and rear brackets 414, 416. For example, the slots 407, 409 may be replaced with a series of holes.

In one embodiment, the holder 400 includes integral structure for attaching the holder 400 to a support structure, such as a wall or upright support. Referring to FIGS. 21-22, the upright portion 406 of the base element 402 may include one or more holes 431 to accommodate one or more fasteners (not shown) extending through a desired one of the holes 431 to attach the holder 400 to the support structure.

The above description is that of the current embodiments of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular. Further, any features of each of the embodiments may be used in any of the other embodiments.

1. An apparatus for supporting a dispensing package, comprising:
a first support element having a first base portion, a first retainer extending from said base portion;
a second support element having a second base portion, a second retainer extending from said second base portion, said first base portion at least partially overlapping said second base portion; and
a fastener connecting said first and second support elements to each other such that the distance between said first retainer and said second retainer is selectively adjustable to a desired dimension corresponding to a dimension of the dispensing package, wherein the dispensing package can be inserted between said first retainer and said second retainer.

2. The apparatus of claim 1 wherein at least one of said first base portion and said second base portion define a slot.

3. The apparatus of claim 2 wherein said first and second retainers are movable in two dimensions.

4. The apparatus of claim 2 wherein said first and second retainers each include an outwardly extending portion forming a ramped outer surface.

5. The apparatus of claim 4 including a ledge extending from said first support element, said dispensing package supported on said ledge.

6. A device for holding a canister style dispensing package comprising:
a first bracket having a first base portion, and a first retainer extending from said base portion, said first retainer having a curved shape portion corresponding to an external shape of a sidewall of the canister style dispensing package;
a second bracket having a second base portion, and a second retainer extending from said second base portion, said second retainer having a curved shape portion corresponding to the external shape of the sidewall of the canister style dispensing package; and
a fastener connecting said first and second brackets to each other such that the distance between said first retainer and said second retainer is selectively adjustable to a desired dimension corresponding to a dimension of the dispensing package, wherein the dispensing package can be inserted between said first retainer and said second retainer and supported between said first retainer and said second retainer by the engagement between said curved shape portions of said first retainer and said second retainer with the external shape of the canister style dispensing package.

7. The device of claim 6 wherein said first bracket includes a ledge extending inwardly therefrom such that the ledge is capable of engaging a portion of the container to support the container.

8. The device of claim 7 wherein said first retainer includes an upper edge, said ledge positioned adjacent said upper edge.

9. The device of claim 8 wherein said upper edge defines a cutout, said ledge positioned within said cutout.

10. The device of claim 9 wherein said ledge extends upwardly within said cutout from a base to a distal end, said distal end of said ledge being generally flush with said upper edge of said retainer, whereby said ledge is capable of flexing with respect to said retainer.

11. The device of claim 10 wherein said ledge includes an upright portion adjacent said base and an angled portion extending from said upright portion, said angled portion angled inwardly toward said second retainer such that said angled portion is capable of extending between a cap portion and a lid portion of the canister style container to support the lid portion.

12. The device of claim 11 wherein said ledge is formed unitarily with said first retainer.

13. The device of claim 12 wherein one of said first bracket base portion and said second bracket base portion defines an elongated slot and the other of said first bracket base portion and said second bracket base portion defines a hole, said hole capable of being selectively adjusted with respect to said slot by a fastener extending through said hole and said slot.

14. The device of claim 13 wherein said one of said first bracket base portion and said second bracket base portion that defines said hole also defines a mounting hole for mounting the apparatus to a support structure, said mounting hole aligned with said hole such that a fastener extending through said mounting hole also extends through said slot.

15. The device of claim 14 wherein said first retainer and said second retainer each include an extension portion between said base portion and said curved portion, said extension portion being generally straight and extending at an angle with respect to said base portion.

16. The device of claim 15 wherein said first retainer extension portion and said second retainer extension portion angle inwardly toward each other.

17. An apparatus for supporting a canister-style dispensing package, comprising:
a first bracket having a bottom edge and a top edge, said first bracket including a rear wall and a sidewall extending at an angle from said rear wall, said sidewall including a first extension portion extending from said rear wall and a first curved portion extending from said first extension portion, said first curved portion shaped to correspond to the shape of the canister-style dispensing package;
a second bracket having a bottom edge and a top edge, said second bracket including a rear wall and a sidewall extending at an angle from said rear wall, said sidewall including a second extension portion extending from said rear wall and a second curved portion extending from said second extension portion, second said curved portion shaped to correspond to the shape of the canister-style dispensing package;
wherein one of said first bracket rear wall and said second bracket rear wall defines an elongated slot, and the other of said first bracket rear wall and said second bracket rear wall defines a hole, said hole aligned with said slot such that said first and second brackets are capable of being secured together by a fastener extending through said hole and said slot, said hole being selectively adjustable with respect to said slot, such that said first bracket sidewall and said second bracket sidewall can be spaced apart at a desired distance;
wherein said one of said first bracket rear wall and said second bracket rear wall that defines said hole also defines a mounting hole for receiving a mounting fastener to mount the apparatus to a support structure, said mounting hole aligned with said slot such that said mounting fastener is capable of extending through said hole and said slot;
wherein the canister style dispensing package can be retained between said curved portions of said first bracket and said second bracket.

18. The apparatus of claim 17 wherein one of said first bracket and said second bracket defines a cutout in said upper edge, said one of said first bracket and said second bracket including a ledge protruding upwardly within said cutout such that said ledge is flexible with respect to said one of said first bracket and said second bracket, a portion of said ledge extending inwardly toward the other of said first bracket and said second bracket.

19. The apparatus of claim 18 wherein said cutout is defined in said upper edge of said curved portion of said one of said first bracket and said second bracket.

20. The apparatus of claim 19 wherein said rear wall of said first bracket portion includes a flange extending at an angle from said rear wall, said flange capable of being grasped by a user to selectively adjust said first bracket with respect to said second bracket.
